(19) United States
(12) Patent Application Publication
(10) Pub. No.: US 2023/0140326 A1
(43) Pub. Date: May 4, 2023

(54) WAVEGUIDE DISPLAY DEVICE AND AUGMENTED REALITY DISPLAY APPARATUS

(71) Applicant: BEIJING XIAOMI MOBILE SOFTWARE CO., LTD., Beijing (CN)

(72) Inventor: Xinhui DUAN, Beijing (CN)

(21) Appl. No.: 17/706,477

(22) Filed: Mar. 28, 2022

(30) Foreign Application Priority Data
Oct. 28, 2021 (CN) 202111262989.X

(51) Int. Cl. G02B 27/01; F21V 8/00

(52) U.S. Cl. CPC G02B 27/0172; G02B 6/0016; G02B 6/0036; G02B 2027/0178

(57) ABSTRACT

A waveguide display device and an augmented reality display apparatus are provided. The waveguide display device includes a waveguide substrate and a first optical element, a second optical element and a third optical element coupled to the waveguide substrate. The first optical element is configured to couple an incident light out to the waveguide substrate. The second optical element is configured to couple the light coupled-in by the waveguide substrate out to the third optical element in a first direction and a second direction. The third optical element is configured to couple the light coupled-in by the second optical element out to the second optical element in the first direction or the second direction, and to couple to the light coupled-in by the second optical element out to the human eye.

### CROSS-REFERENCE TO RELATED APPLICATION

This application is based on and claims priority to Chinese Patent Application No. 202111262989.X filed on Oct. 28, 2021, the entire content of which is incorporated herein by reference.

### BACKGROUND

An augmented reality (AR) near-to-eye display technology is a wearable display system that enables a human eye to see an external real scene, and also to see a virtual scene generated by a computer through a certain optical system. In the augmented reality system, a computing component analyzes and processes the real scene observed by a user, and then the generated virtual enhancement information is superimposed into the real scene through the near-to-eye display technology, so as to realize a seamless integration of the real scene and the virtual scene, thus assisting the user in recognizing the real world deeply and comprehensively. The AR apparatus has been applied in many fields, including military, navigation, education, medical treatment, industry and so on, and has broad applications in the field of electronic consumption. As one of the core technologies of the AR apparatus, the near-to-eye display technology has also become a research hotspot in industry and academia.

### SUMMARY

The present disclosure relates to a field of augmented reality technology, and more particularly, to a waveguide display device and an augmented reality display apparatus.

Embodiments of a first aspect of the present disclosure provide a waveguide display device. The waveguide display device includes a waveguide substrate and a first optical element, a second optical element and a third optical element coupled to the waveguide substrate. The first optical element is located on a first side of the waveguide substrate. The first optical element is adjacent to a first surface of the waveguide substrate and configured to couple an incident light out to the waveguide substrate, and the first surface of the waveguide substrate is a surface of the waveguide substrate facing away from a human eye. The waveguide substrate is configured to couple the light coupled-in by the first optical element out to the second optical element. The second optical element and the third optical element are located on a second side of the waveguide substrate. The second optical element is adjacent to a second surface of the waveguide substrate and is configured to couple the light coupled-in by the waveguide substrate out to the third optical element in a first direction and a second direction when viewed in a direction perpendicular to a plane where the third optical element is located. The second surface of the waveguide substrate is a surface of the waveguide substrate facing the human eye. The third optical element is adjacent to the first surface of the waveguide substrate and is configured to couple the light coupled-in by the second optical element out to the second optical element in the first direction or the second direction when viewed in the direction perpendicular to the plane where the third optical element is located, and to couple the light coupled-in by the second optical element out to the human eye. The light coupled out to the second optical element continues to propagate many times between the second optical element and the third optical element in the first direction or the second direction.

Embodiments of a second aspect of the present disclosure provide an augmented reality display apparatus. The augmented reality display apparatus includes a waveguide display device and an optical machine. The waveguide display device includes a waveguide substrate and a first optical element, a second optical element and a third optical element coupled to the waveguide substrate. The first optical element is located on a first side of the waveguide substrate. The first optical element is adjacent to a first surface of the waveguide substrate and configured to couple a light incident from the optical machine out to the waveguide substrate, and the first surface of the waveguide substrate is a surface of the waveguide substrate facing away from a human eye. The waveguide substrate is configured to couple the light coupled-in by the first optical element out to the second optical element. The second optical element and the third optical element are located on a second side of the waveguide substrate. The second optical element is adjacent to a second surface of the waveguide substrate and is configured to couple the light coupled-in by the waveguide substrate out to the third optical element in a first direction and a second direction when viewed in a direction perpendicular to a plane where the third optical element is located. The second surface of the waveguide substrate is a surface of the waveguide substrate facing the human eye. The third optical element is adjacent to the first surface of the waveguide substrate and is configured to couple the light coupled-in by the second optical element out to the second optical element in the first direction or the second direction when viewed in the direction perpendicular to the plane where the third optical element is located, and to couple the light coupled-in by the second optical element out to the human eye, and the light coupled out to the second optical element continues to propagate many times between the second optical element and the third optical element in the first direction or the second direction.

It should be understood that the above general description and the following detailed description are only exemplary and explanatory and do not limit the present disclosure.

### BRIEF DESCRIPTION OF THE DRAWINGS

Accompanying drawings herein are incorporated into the specification and constitute a part of the specification. The accompanying drawings show embodiments consistent with the present disclosure, and together with the specification are used to explain the principle of the present disclosure. However, they do not constitute an improper limitation to the present disclosure.

FIG. 1 is a schematic view of various geometric parameters in a formation stage of a two-dimensional confined volume grating according to an embodiment of the present disclosure.

FIG. 2 is a schematic view of various geometric parameters in a readout stage of a two-dimensional confined volume grating according to an embodiment of the present disclosure.

FIG. 3 is a schematic view of a waveguide display device according to an embodiment of the present disclosure.

FIG. 4 is a scene view of a waveguide display device according to an embodiment of the present disclosure.

FIG. 5 is an exploded view of a waveguide display device according to an embodiment of the present disclosure.

FIG. 6 is a schematic view of light propagation of a waveguide display device according to an embodiment of the present disclosure.

FIG. 7 is a schematic view of light propagation in a X-axis direction and a Z-axis direction according to an embodiment of the present disclosure.

FIG. 8 is a schematic view of light propagation in a Y-axis direction and a Z-axis direction according to an embodiment of the present disclosure.

FIG. 9 is a schematic view of AR glasses according to an embodiment of the present disclosure.

FIG. 10 is a scene view of a head-up display apparatus according to an embodiment of the present disclosure.

### DETAILED DESCRIPTION

In order to enable those ordinary skilled in the art to better understand the technical solutions of the present disclosure, the technical solutions in embodiments of the present disclosure will be clearly and completely described below in combination with the accompanying drawings.

It should be noted that the terms “first,” “second” and the like in the descriptions, claims and the above accompanying drawings of the present disclosure are used to distinguish similar objects, and not necessary be used to describe a specific sequence or order. It should be understood that the terms used in this manner can be interchanged where appropriately so that the embodiments of the present disclosure described herein can be implemented in an order other than those illustrated or described herein. The implementations described in the following embodiments do not represent all implementations consistent with the present disclosure. On the contrary, they are only examples of devices and methods consistent with some aspects of the present disclosure as detailed in the appended claims.

A core task of AR near-to-eye display technology is for virtual and real superimposition, that is, to allow a light of the real world and a light of a virtual image to pass through and reach the human eye simultaneously. The near-to-eye display technology includes a geometrical optics superimposer technology and the near-to-eye display technology based on diffractive optics.

At present, the near-to-eye display technology based on diffractive optics has a small range of an exit pupil, a volume of the apparatus is large, and a weight of the apparatus is relatively large.

Specifically, a waveguide display device of the near-to-eye display technology based on diffractive optics includes: an in-coupling diffractive element, a relay diffractive element and an out-coupling diffractive element. The relay diffractive element is located above the out-coupling diffractive element. A remaining space of the out-coupling diffractive element is small, and a range of an exit pupil is small. A space occupied by the relay diffractive element is large. A volume and a weight of the waveguide display device are relatively large, which is not conducive to the miniaturization design of the waveguide display device.

The basic principle of the near-to-eye display technology is described below.

There are two kinds of the near-to-eye display technology based on diffractive optics, namely a waveguide device based on a surface relief grating and a waveguide device based on a volume holographic grating. The embodiments of the present disclosure mainly describe the waveguide device of the volume holographic grating.

The mathematical expression of the coupled wave theory includes coupling differential equations derived from the wave equation, whose main principle is that individual light waves continuously exchange energy in the process of propagation inside the hologram. Kogelnik coupled wave theory is widely used to analyze diffraction characteristics of various volume gratings and give a quantitative result. Since the Kogelnik theory implies the assumption that a wavefront size of a light participating in diffraction is infinite, only a change of the light during propagation along a thickness direction of the grating is studied under this assumption. Thus, the Kogelnik theory is essentially a one-dimensional theory. A two-dimensional theory assumes that properties of a material and properties of the light wave are all unchanged in a direction along a grating fringe plane. Usually, this direction is designated as a direction of an electric vector of the light wave. A size of the grating is limited in two directions perpendicular to the grating fringe plane, so that the light waves couple with each other and change uniformly in the two directions.

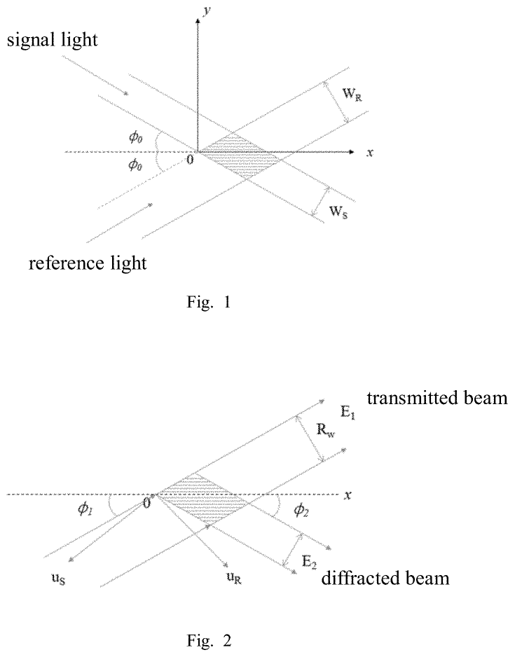

FIG. 1 is a schematic view of various geometric parameters in a formation stage of a two-dimensional confined volume grating. FIG. 2 is a schematic view of various geometric parameters in a readout stage of a two-dimensional confined volume grating. A reference light with a width of WR and a signal light with a width of WS are incident into a medium and interfere with each other inside the medium to form a volume grating. A coordinate system is selected so that the reference light and the signal light are incident at an angle ϕ0 and an angle −ϕ0 relative to a X axis, respectively. The formed grating is denoted as a periodic change of a dielectric constant εᵣ of the medium:

εᵣ=εᵣ₀+εᵣ₁a₁₀a₂₀ cos[β₀(p₁₀−p₂₀)].

In the equation, εᵣ₀ is an average dielectric constant, and εᵣ₁ is an amplitude of a change of the dielectric constant. εᵣ₀ and εᵣ₁ can be a complex value, an imaginary part of which represents a change of an average absorptivity and a modulation amplitude of the absorption grating, respectively. pᵢ₀ is a wavefront phase function of a plane light wave, and is denoted in the X-Y coordinate system as pᵢ₀=x cos ϕ₀−(−1)ⁱ y sin ϕ₀, in which i (i=1, 2) represents the reference light and the signal light, respectively. a₁₀ and a₂₀ represents normalized complex amplitude distributions on wave fronts of two writing light waves respectively, and β₀ is a propagation constant of the writing light wave.

For the two-dimensional grating, the category of the Bragg diffraction is considered, and a grating vector k is denoted as:

K=δWs(u_{R}+u_{S}).

A Bragg mismatch parameter δ in the grating vector k is denoted as:

$$δ = \frac{1}{2} βΔϕ {sec}^{2} {ϕ}_{0} + Δβ tan {ϕ}_{0} .$$

In the equation, β=2π/λ is a propagation constant of a readout light wave, λ is a wavelength of the readout light wave, and Δϕ and Δβ represent deviations of an angle and a wavelength of the readout light wave from the Bragg condition, respectively.

When discussing the diffraction characteristics of fully overlapped uniform grating (κ is constant), for a two-dimensional finite-size volume grating, a grating diffraction efficiency is defined as:

$$η = \frac{{{\int }_{- 1}}^{0} {\vert {E}_{2} ( {R}_{w} , {u}_{S} ) \vert}^{2} {du}_{S}}{{{\int }_{- 1}}^{{R}_{w}} {\vert {E}_{1} ( {u}_{R} , 0 ) \vert}^{2} {du}_{R}} .$$

In view of the above existing technical problems, in some embodiments of the present disclosure, a waveguide display device includes: a waveguide substrate and a first optical element, a second optical element and a third optical element arranged coupled to the waveguide substrate. The first optical element is configured to couple an incident light out to the waveguide substrate. The waveguide substrate is configured to couple the light coupled-in by the first optical element out to the second optical element. The second optical element is configured to couple the light coupled-in by the waveguide substrate out to the third optical element in a first direction and a second direction. The third optical element is configured to couple the light coupled-in by the second optical element out to the second optical element in the first direction or the second direction, and to couple the light coupled-in by the second optical element out to a human eye. The second optical element and the third optical element are arranged at a first surface and a second of the waveguide substrate, respectively, and a relay optical element is omitted, so that the second optical element and the third optical element provide a large design space, thus reducing a volume and a weight of the waveguide display device. Moreover, the light coupled out to the second optical element continues to propagate many times between the second optical element and the third optical element in the first direction or the second direction, so as to realize a two-dimensional mydriasis.

In this embodiment, an augmented reality display apparatus includes but is not limited to AR glasses, an AR head-mounted display apparatus and a head-up display apparatus. When the augmented reality display apparatus includes the AR glasses, the type of the AR glasses is not limited, which can be monocular AR glasses or binocular AR glasses.

In an embodiment, when the augmented reality display apparatus includes the AR glasses, the AR glasses include a frame, a waveguide display device and an optical machine. The waveguide display device and the optical machine are arranged on the frame. The waveguide display device serves as a lens of the AR glasses, and the optical machine sends an image light to the waveguide display device. The optical machine is not limited in the present disclosure, as long as it can emit a light to the waveguide display device. That is, any light emitter known in the related art may be used herein. The waveguide display device will be described in detail in subsequent embodiments, and will not be repeated in this embodiment.

In another embodiment, when the augmented reality display apparatus is the head-up display apparatus, the head-up display apparatus includes a body, a waveguide display device and an optical machine. The body and the optical machine are arranged on the body. The optical machine is not limited in the present disclosure, as long as it can emit a light to the waveguide display device. That is, any light emitter known in the related art may be used herein. The waveguide display device will be described in detail in subsequent embodiments, and will not be repeated in this embodiment.

In the above embodiments, the optical machine provides a collimated image source by projection.

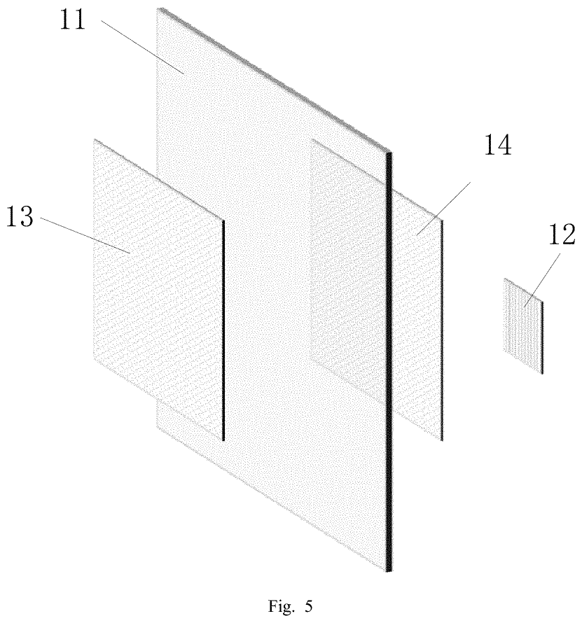

FIG. 3 is a schematic view of a waveguide display device 1 according to an embodiment of the present disclosure. FIG. 5 is an exploded view of a waveguide display device according to an embodiment of the present disclosure. As shown in FIG. 3 and FIG. 5, a waveguide display device 1 includes a waveguide substrate 11 and a first optical element 12, a second optical element 13 and a third optical element 14 arranged coupled to the waveguide substrate 11. As used herein the first and second sides of waveguide substrate 11 are relative to the X axis of FIG. 3. The first and second surfaces of waveguide substrate 11 are relative to the Z axis of FIG. 3. The first optical element 12 is located on a first side of the waveguide substrate 11. For example, the first optical element 12 is located at a right part of the waveguide substrate 11 in FIG. 3 and FIG. 5. The first optical element 12 is arranged adjacent to a first surface of the waveguide substrate 11 and configured to couple an incident light out to the waveguide substrate 11. The first surface of the waveguide substrate 11 is a side surface of the waveguide substrate 11 facing away from the human eye. The waveguide substrate 11 is configured to couple the light coupled-in by the first optical element 12 out to the second optical element 13. The second optical element 13 and the third optical element 14 are located on a second side of the waveguide substrate 11. For example, the second optical element 13 and the third optical element 14 are located at a left part of the waveguide substrate 11 in FIG. 3 and FIG. 5. The second optical element 13 is arranged adjacent to a second surface of the waveguide substrate 11 and is configured to couple the light coupled-in by the waveguide substrate 11 out to the third optical element 14 in a first direction and a second direction when viewed in a direction perpendicular to a plane where the third optical element 14 is located. The second surface of the waveguide substrate 11 is a side surface of the waveguide substrate 11 facing the human eye. The first direction and the second direction are directions defined in the plane where the third optical element 14 is located. That is, the first direction and the second direction have no component in the direction perpendicular to the plane where the third optical element 14 is located. The third optical element 14 is arranged adjacent to the first surface of the waveguide substrate 11 and configured to couple the light coupled-in by the second optical element 13 out to the second optical element 13 in the first direction or the second direction when viewed in a direction perpendicular to the plane where the third optical element 14 is located, and to couple the light coupled-in by the second optical element 13 out to the human eye. Moreover, the light coupled-out to the second optical element 13 continues to propagate many times between the second optical element 13 and the third optical element 14 in the first direction or the second direction.

In some embodiments, the first optical element 12 and the third optical element 14 are on the first surface of the waveguide substrate 11 and spaced apart from each other, and the second optical element 13 is on the second surface of the waveguide substrate 11 and opposite to the third optical element 14.

The waveguide display device according to the embodiments of the present disclosure includes the waveguide substrate and the first optical element, the second optical element and the third optical element coupled to the waveguide substrate. The first optical element is configured to couple the incident light out to the waveguide substrate. The waveguide substrate is configured to couple the light coupled-in by the first optical element out to the second optical element. The second optical element is configured to couple the light coupled-in by the waveguide substrate out to the third optical element in the first direction and the second direction. The third optical element is configured to couple the light coupled-in by the second optical element out to the second optical element in the first direction or the second direction, and to couple the light coupled-in by the second optical element out to the human eye. The second optical element and the third optical element are arranged at the first surface and the second surface of the waveguide substrate, respectively, and a relay optical element is omitted, so that a volume and a weight of the waveguide display device are reduced. Moreover, the light coupled-out to the second optical element continues to propagate many times between the second optical element and the third optical element in the first direction or the second direction, so as to realize a two-dimensional mydriasis.

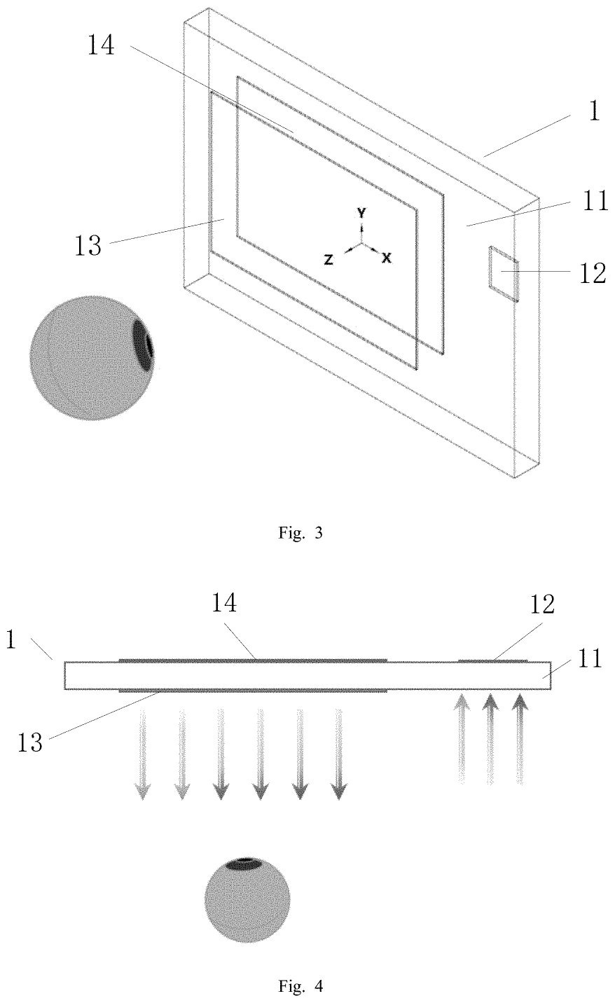

FIG. 4 is a scene view of a waveguide display device 1 according to an embodiment of the present disclosure. As shown in FIG. 3 and FIG. 4, the light is incident on a surface of the first optical element 12, and the first optical element 12 forwards the incident light to go through action of the waveguide substrate 11, the second optical element 13 and the third optical element 14, so as to realize the two-dimensional mydriasis in a X-axis direction and a Y-axis direction shown in FIG. 3. Then, the light is incident on the human eye, and a virtual field of view is formed in front of the human eye.

It should be noted that, in FIG. 3, a X axis of a coordinate system is parallel to a length direction of the waveguide display device 1 or a horizontal axis of the virtual field of view, a Y axis of the coordinate system is parallel to a width direction of the waveguide display device 1, and a Z axis of the coordinate system is perpendicular to the waveguide display device or parallel to a thickness direction of the waveguide display device 1.

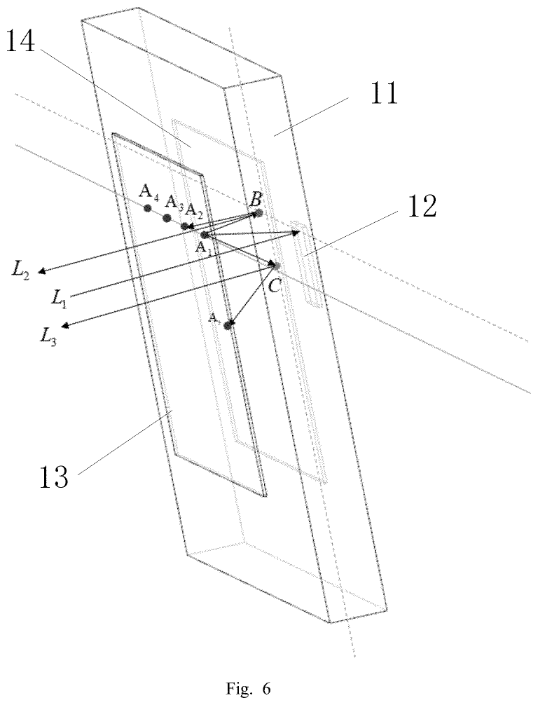

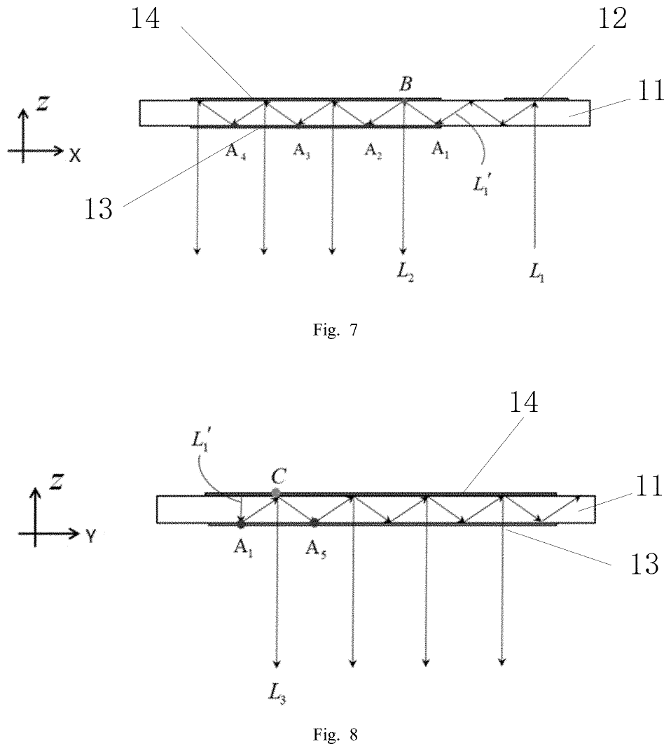

FIG. 6 is a schematic view of light propagation of a waveguide display device 1 according to an embodiment of the present disclosure. FIG. 7 is a schematic view of light propagation in a X-axis direction and a Z-axis direction according to an embodiment of the present disclosure. FIG. 8 is a schematic view of light propagation in a Y-axis direction and a Z-axis direction according to an embodiment of the present disclosure.

It should be noted that, for an illustrative purpose, embodiments of FIG. 6 and FIG. 7 take any one (a light L1) of lights emitted by the optical machine as an example. A light L₁′ in FIG. 7 and FIG. 8 is the light incident on the second optical element 13 from the waveguide substrate 11. The following embodiments are described with reference to any light L1.

In the above embodiments, as shown in FIGS. 4 to 8, the light L1 emitted by the optical machine is incident on the first optical element 12 and is diffracted into the waveguide substrate 11 by the first optical element 12. The waveguide substrate 11 is configured to couple the light coupled-in by the first optical element 12 out to the second optical element 13. A method in which the waveguide substrate 11 couples the light coupled-in by the first optical element 12 out to the second optical element 13, includes but is not limited to following light processing methods.

First Light processing method: the waveguide substrate 11 is configured to directly couple the light coupled-in by the first optical element 12 out to the second optical element 13. In this light processing method, a relative position of the first optical element 12 and the second optical element 13 may be adjusted, so as to directly couple the light coupled-in by the first optical element 12 out to the second optical element 13 through the waveguide substrate 11.

Second light processing method: the waveguide substrate 11 is configured to couple the light coupled-in by the first optical element 12 out to the second optical element 13 after the light coupled-in by the first optical element 12 goes through at least one total reflection inside the waveguide substrate 11. As shown in FIG. 7, the light coupled-in by the first optical element 12 meets a condition of the total reflection in the waveguide substrate 11, and the light coupled-in by the first optical element 12 forms the light L₁′ after the total reflection and the light L₁′ is incident on the second optical element 13.

In some embodiments, the first direction is perpendicular to the second direction. In some embodiments, the first direction is parallel to the X axis of the coordinate system, and the second direction is parallel to the Y axis of the coordinate system. It should be noted that the first direction and the second direction may not be parallel to the X axis of the coordinate system or the Y axis of the coordinate system. In this case, an inclined virtual field of view is formed in front of the human eye.

In some embodiments, the first optical element 12, the second optical element 13 and the third optical element 14 are nanostructures to diffract the incident light.

In the above embodiments, the second optical element 13 is configured to couple the light coupled-in by the waveguide substrate 11 out to the third optical element 14 by total reflection in the first direction, and to couple the light coupled-in by the waveguide substrate 11 out to the third optical element 14 by diffraction in the second direction. As shown in FIG. 6, FIG. 7 and FIG. 8, the light coupled-in by the first optical element 12 forms the light L₁′ after the total reflection and the light L₁′ is incident on the second optical element 13 at a point A1. The light L₁′ meets the condition of the total reflection at the point A1. The second optical element 13 reflects the light L₁′ at the point A1 to a point B of the third optical element 14 along the X-axis direction of the coordinate system by the total reflection, and the light reflected by the second optical element 13 at the point A1 is a zero order light. The second optical element 13 couples the light L₁′ at the point A1 out to a point C of the third optical element 14 along the Y-axis direction of the coordinate system by the diffraction, and the light generated by the second optical element 13 at the point A1 by the diffraction is a diffraction order light.

In the above embodiments, the third optical element 14 is configured to couple the light coupled-in by the second optical element 13 out to the second optical element 13 in the first direction or the second direction by the total reflection, and to couple the light coupled-in by the second optical element 13 out to the human eye by the diffraction. The third optical element 14 is configured to couple the light coupled-in by the second optical element 13 out to the human eye in the direction perpendicular to the plane where the third optical element 14 is located. As shown in FIG. 6, FIG. 7 and FIG. 8, the light coupled-in by the second optical element 13 meets the condition of the total reflection at the point B, the third optical element 14 is configured to reflect the light coupled-in by the second optical element 13 at the point B to a point A2 of the second optical element 13 along the X-axis direction of the coordinate system by the total reflection, and also, the third optical element 14 is configured to couple the light coupled-in by the second optical element 13 at the point B out to the human eye by the diffraction. The light coupled-in by the second optical element 13 meets the condition of the total reflection at the point C, the third optical element 14 is configured to reflect the light coupled-in by the second optical element 13 at the point C to a point A5 of the second optical element 13 along the Y-axis direction of the coordinate system by the total reflection, and also, the third optical element 14 is configured to couple the light coupled-in by the second optical element 13 at the point C out to the human eye by the diffraction.

It may be understood that, for convenient and easy understanding of the present disclosure, a travel path of the light is mainly described in the plane where the third optical element 14 is located, i.e. a projection of the travel path of the light on the plane where the third optical element 14 is located is mainly described.

However, in the above embodiments, the light coupled out to the second optical element 13 from the third optical element 14 continues to propagate many times between the second optical element 13 and the third optical element 14 in the first direction or the second direction, that is, the light actually has a displacement in the direction (i.e. the Z-axis direction) perpendicular to the plane where the third optical element 14 is located. As shown in FIG. 7, the light coupled out to the second optical element 13 from the third optical element 14 continues to propagate many times between the second optical element 13 and the three optical elements 14 along the X-axis direction and the Z-axis direction of the coordinate system, and as shown in FIG. 8, the light coupled out to the second optical element 13 from the third optical element 14 continues to propagate many times between the second optical element 13 and the three optical elements 14 along the Y-axis direction and the Z-axis direction of the coordinate system, so as to realize the two-dimensional mydriasis.

It should be noted that, as shown in FIG. 6, the zero order light and the diffraction order light are subject to exactly identical modulation at the point A1, the point A2, a point A3, a point A4 and the point A5 in the drawings. A light intensity may be adjusted according to requirements of a brightness uniformity of an actual field of view. In the actual processing, a photomask may be arranged to control a grating efficiency.

In some embodiments, the second optical element 13 and the third optical element 14 are opposite to each other, and an area of the second optical element 13 and an area of the third optical element 14 are equal. The second optical element 13 and the third optical element 14 are opposite to each other, so that the relay optical element does not need to be arranged, so as to reserve a design space for the second optical element 13 and the third optical element 14. In this way, the second optical element 13 and the third optical element 14 may adopt a larger area, thus improving a range of the mydriasis, reasonably setting a position of an exit pupil area and ensuring a reasonable observation range. The area of the second optical element 13 and the area of the third optical element 14 are equal, so that the second optical element 13 and the third optical element 14 may be processed simultaneously, thus improving the production efficiency of the elements.

In some embodiments, the first optical element 12, the second optical element 13 and the third optical element 14 are arranged adjacent to the surfaces of the waveguide substrate 11. As shown in FIGS. 3 to 8, the first optical element 12 covers at least a part of the first surface of the waveguide substrate 11, the second optical element 13 covers at least a part of the second surface of the waveguide substrate 11, and the third optical element 14 covers at least another part of the first surface of the waveguide substrate 11. In the embodiments of the present disclosure, the first optical element 12, the second optical element 13 and the third optical element 14 may be adjusted according to the actual situation. For example, the first optical element 12, the second optical element 13 and the third optical element 14 may be embedded inside the waveguide substrate 11 in a totally enclosed form. In some embodiments, the surface of the waveguide substrate 11 is provided with a groove, and the first optical element 12, the second optical element 13 and the third optical element 14 are mounted in the groove in the surface of the waveguide substrate 11 in a semi-enclosed form.

In some embodiments, the second optical element 13 and the third optical element 14 are parallel to each other. The second optical element 13 and the third optical element 14 may adopt same grating structure parameters, so as to symmetrically modulate the light.

In some embodiments, the first optical element 12 is a one-dimensional grating. The one-dimensional grating includes but is not limited to any one of the following gratings: an inclined grating, a rectangular grating, a blazed grating and a volume grating. The second optical element 13 and the third optical element 14 are the two-dimensional gratings. The first optical element 12 is a holographic one-dimensional grating, and the second optical element 13 and the third optical element 14 are holographic two-dimensional gratings. The second optical element 13 and the third optical element 14 in the present disclosure adopt the holographic two-dimensional grating, so that the efficiency of the diffraction waveguide can be greatly improved.

The technical solution of the embodiments of the present disclosure is described in detail below in combination with FIGS. 6 to 8.

As shown in FIG. 4, the light coupled-in by the first optical element 12 meets the condition of the total reflection in the waveguide substrate 11, the light coupled-in by the first optical element 12 forms the light L₁′ after the total reflection and the light L₁′ is incident on the second optical element 13.

As shown in FIG. 6 and FIG. 7, the light coupled-in by the first optical element 12 forms the light L₁′ after the total reflection and the light is incident on the point A1 of the second optical element 13. The light L₁′ meets the condition of the total reflection at the point A1. The second optical element 13 reflects the light L₁′ at the point A1 to the point B of the third optical element 14 along the X-axis direction of the coordinate system by the total reflection, and the light reflected by the second optical element 13 at the point A1 is the zero order light. The second optical element 13 couples the light L₁′ at the point A1 out to the point C of the third optical element 14 along the Y-axis direction of the coordinate system by the diffraction, and the light generated by the second optical element 13 at the point A1 by the diffraction is the diffraction order light.

As shown in FIG. 6 and FIG. 8, the light coupled-in by the second optical element 13 meets the condition of the total reflection at the point B, the third optical element 14 is configured to reflect the light coupled-in by the second optical element 13 at the point B to the point A2 of the second optical element 13 along the X-axis direction of the coordinate system by the total reflection, and also, the third optical element 14 is configured to couple the light coupled-in by the second optical element 13 at the point B out to the human eye. The light coupled-in by the second optical element 13 meets the condition of the total reflection at the point C, the third optical element 14 is configured to reflect the light coupled-in by the second optical element 13 at the point C to the point A5 of the second optical element 13 along the Y-axis direction of the coordinate system by the total reflection, and also, the third optical element 14 is configured to couple the light coupled-in by the second optical element 13 at the point C out to the human eye by the diffraction.

As shown in FIG. 7, the light coupled out to the second optical element 13 from the third optical element 14 continues to propagate many times between the second optical element 13 and the three optical elements 14 along the X-axis direction and Z-axis direction of the coordinate system, and as shown in FIG. 8, the light coupled out to the second optical element 13 from the third optical element 14 continues to propagate many times between the second optical element 13 and the three optical elements 14 along the Y-axis direction and the Z-axis direction of the coordinate system, so as to realize the two-dimensional mydriasis.

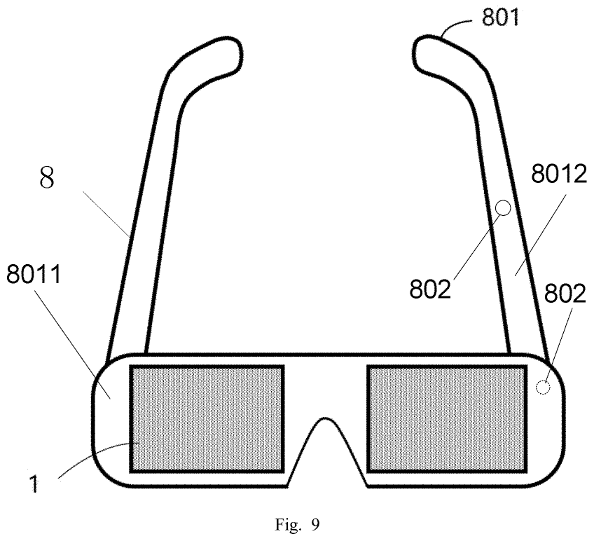

FIG. 9 is a schematic view of AR glasses according to an embodiment of the present disclosure. Taking a scene of the AR glasses as an example, the technical solution of the present disclosure is described in combination with FIGS. 3 to 8.

As shown in FIG. 9, the AR glasses 8 include a frame 801, the waveguide display device 1 according to any one of the above embodiments and an optical machine 802, and the waveguide display device 1 and the optical machine are arranged on the frame 801. The frame 801 includes an eyeglass frame 8011 and lens legs 8012 connected to two sides of the eyeglass frame 8011. The optical machine 802 may be arranged on the eyeglass frame 8011 or on the lens leg 8012 on either side.

In the waveguide display device 1 according to the embodiments of the present disclosure, the second optical element 13 and the third optical element 14 are arranged at the first surface and the second surface of the waveguide substrate 11, respectively. The relay optical element is omitted, so that a large design space is provided for the second optical element 13 and the third optical element 14, a range of the mydriasis of the waveguide display device 1 is increased, and an observable range for the human eye to watch a virtual image in a real scene through the AR glasses is increased. The virtual image in the real scene can be watched through the AR glasses no matter the AR glasses are offset upwards, downwards, leftwards or rightwards relative to human eye, thus improving the user experience. The AR glasses may be adapted to users having different habits of wearing AR glasses.

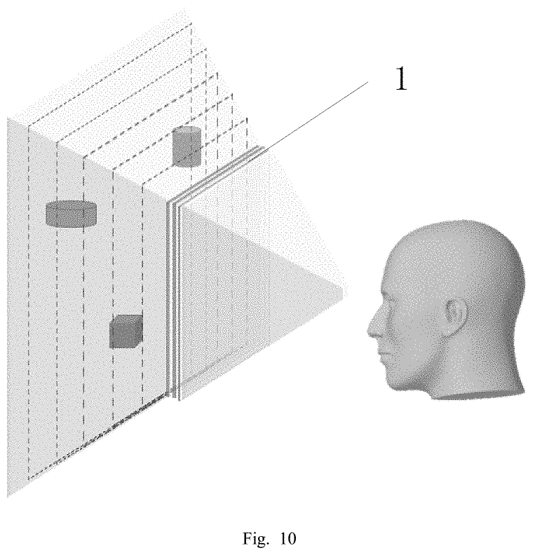

FIG. 10 is a scene view of a head-up display apparatus according to an embodiment of the present disclosure. Taking the scene of the head-up display apparatus as an example, the technical solution of the present disclosure is described in combination with FIGS. 3 to 8.

The augmented reality display apparatus is arranged on a front windshield of a vehicle. The augmented reality display apparatus includes the waveguide display device 1 according to any one of the above embodiments and an optical machine. Part of the front glass of the vehicle may be configured as the waveguide substrate 11 of the augmented reality display apparatus. The first optical element 12, the second optical element 13 and the third optical element 14 may be arranged on a surface of the part of the glass.

In the waveguide display device 1 according to the embodiments of the present disclosure, the second optical element 13 and the third optical element 14 are arranged at the first surface and the second surface of the waveguide substrate 11, respectively. The relay optical element is omitted, so that a large design space is provided for the second optical element 13 and the third optical element 14, a range of the mydriasis of the waveguide display device 1 is increased, and an observable range for the human eye to watch a virtual image in a real scene through the head-up display apparatus is increased. Moreover, the observable range for the human eye to watch the virtual image in the real scene through the head-up display apparatus may be adjusted by reasonably setting positions and sizes of the second optical element 13 and the third optical element 14.

Embodiments of a first aspect of the present disclosure provide a waveguide display device. The waveguide display device includes a waveguide substrate and a first optical element, a second optical element and a third optical element coupled to the waveguide substrate. The first optical element is located on a first side of the waveguide substrate. The first optical element is adjacent to a first surface of the waveguide substrate and configured to couple an incident light out to the waveguide substrate, and the first surface of the waveguide substrate is a surface of the waveguide substrate facing away from a human eye. The waveguide substrate is configured to couple the light coupled-in by the first optical element out to the second optical element. The second optical element and the third optical element are located on a second side of the waveguide substrate. The second optical element is adjacent to a second surface of the waveguide substrate and is configured to couple the light coupled-in by the waveguide substrate out to the third optical element in a first direction and a second direction when viewed in a direction perpendicular to a plane where the third optical element is located. The second surface of the waveguide substrate is a se surface of the waveguide substrate facing the human eye. The third optical element is adjacent to the first surface of the waveguide substrate and is configured to couple the light coupled-in by the second optical element out to the second optical element in the first direction or the second direction when viewed in the direction perpendicular to the plane where the third optical element is located, and to couple the light coupled-in by the second optical element out to the human eye. The light coupled out to the second optical element continues to propagate many times between the second optical element and the third optical element in the first direction or the second direction.

In some embodiments, the second optical element is configured to couple the light coupled-in by the waveguide substrate out to the third optical element in the first direction by total reflection, and to couple the light coupled-in by the waveguide substrate out to the third optical element in the second direction by diffraction.

In some embodiments, the third optical element is configured to couple the light coupled-in by the second optical element out to the second optical element in the first direction or the second direction by total reflection, and to couple the light coupled-in by the second optical element out to the human eye by diffraction.

In some embodiments, the waveguide substrate is configured to couple the light coupled-in by the first optical element out to the second optical element after the light coupled-in by the first optical element goes through at least one total reflection inside the waveguide substrate.

In some embodiments, the second optical element and the third optical element are opposite to each other, and an area of the second optical element and an area of the third optical element are equal.

In some embodiments, the third optical element is configured to couple the light coupled-in by the second optical element out to the human eye in a direction perpendicular to the plane where the third optical element is located.

In some embodiments, the first direction is perpendicular to the second direction.

In some embodiments, the second optical element and the third optical element are parallel to each other.

In some embodiments, the first optical element covers at least a part of the first surface of the waveguide substrate.

In some embodiments, the second optical element covers at least a part of the second surface of the waveguide substrate, the third optical element covers at least a part of the first surface of the waveguide substrate, and the second optical element is opposite to the third optical element.

In some embodiments, the first optical element is a one-dimensional grating, and the second optical element and the third optical element are two-dimensional gratings.

Embodiments of a second aspect of the present disclosure provide an augmented reality display apparatus. The augmented reality display apparatus includes a waveguide display device and an optical machine. The waveguide display device includes a waveguide substrate and a first optical element, a second optical element and a third optical element coupled to the waveguide substrate. The first optical element is located on a first side of the waveguide substrate. The first optical element is adjacent to a first surface of the waveguide substrate and configured to couple a light incident from the optical machine out to the waveguide substrate, and the first surface of the waveguide substrate is a surface of the waveguide substrate facing away from a human eye. The waveguide substrate is configured to couple the light coupled-in by the first optical element out to the second optical element. The second optical element and the third optical element are located on a second side of the waveguide substrate. The second optical element is adjacent to a second surface of the waveguide substrate and is configured to couple the light coupled-in by the waveguide substrate out to the third optical element in a first direction and a second direction when viewed in a direction perpendicular to a plane where the third optical element is located. The second surface of the waveguide substrate is a surface of the waveguide substrate facing the human eye. The third optical element is adjacent to the first surface of the waveguide substrate and is configured to couple the light coupled-in by the second optical element out to the second optical element in the first direction or the second direction when viewed in the direction perpendicular to the plane where the third optical element is located, and to couple the light coupled-in by the second optical element out to the human eye, and the light coupled out to the second optical element continues to propagate many times between the second optical element and the third optical element in the first direction or the second direction.

In some embodiments, the augmented reality display apparatus is AR glasses, an AR head-mounted display apparatus and a head-up display apparatus.

It should be noted that relational terms herein such as “first” and “second” are only used to distinguish an entity or operation from another entity or operation, and do not necessarily require or imply that any such actual relationship or order exists between these entities or operations. Moreover, terms “comprise,” “include” or any other variations are intended to cover non-exclusive inclusion, so that a process, a method, an article or an apparatus including a series of elements includes not only those elements, but also other elements not explicitly listed, or also includes elements inherent for such process, method, article or apparatus. Without further restrictions, an element defined by the statement “including a . . . ” does not exclude the existence of other identical elements in the process, method, article or apparatus including this element.

The above description is only the specific implementation of the present disclosure, which enables those skilled in the related art to understand or implement the present disclosure. Various modifications to these embodiments will be apparent to those skilled in the related art, and the general principles defined herein may be implemented in other embodiments without departing from the spirit or scope of the present disclosure. Therefore, the present disclosure will not be limited to these embodiments herein, but will conform to the widest scope consistent with the principles and novel characteristics disclosed herein.

What is claimed is:

1. A waveguide display device, comprising a waveguide substrate and a first optical element, a second optical element and a third optical element coupled to the waveguide substrate,
wherein the first optical element is located on a first side of the waveguide substrate, the first optical element is adjacent to a first surface of the waveguide substrate and configured to couple an incident light out to the waveguide substrate, and the first surface of the waveguide substrate is a surface of the waveguide substrate facing away from a human eye;
the waveguide substrate is configured to couple the light coupled-in by the first optical element out to the second optical element;
the second optical element and the third optical element are located on a second side of the waveguide substrate, the second optical element is adjacent to a second surface of the waveguide substrate, the second optical element is configured to couple the light coupled-in by the waveguide substrate out to the third optical element in a first direction and a second direction when viewed in a direction perpendicular to a plane where the third optical element is located, and the second surface of the waveguide substrate is a surface of the waveguide substrate facing the human eye; and
the third optical element is arranged adjacent to the first surface of the waveguide substrate, the third optical element is configured to couple the light coupled-in by the second optical element out to the second optical element in the first direction or the second direction when viewed in the direction perpendicular to the plane where the third optical element is located, and to couple the light coupled-in by the second optical element out to the human eye, and the light coupled out to the second optical element continues to propagate many times between the second optical element and the third optical element in the first direction or the second direction.

2. The waveguide display device according to claim 1, wherein the second optical element is configured to couple the light coupled-in by the waveguide substrate out to the third optical element in the first direction by total reflection, and to couple the light coupled-in by the waveguide substrate out to the third optical element in the second direction by diffraction.

3. The waveguide display device according to claim 1, wherein the third optical element is configured to couple the light coupled-in by the second optical element out to the second optical element in the first direction or the second direction by total reflection, and to couple the light coupled-in by the second optical element out to the human eye by diffraction.

4. The waveguide display device according to claim 1, wherein the waveguide substrate is configured to couple the light coupled-in by the first optical element out to the second optical element after the light coupled-in by the first optical element goes through at least one total reflection inside the waveguide substrate.

5. The waveguide display device according to claim 1, wherein the second optical element and the third optical element are opposite to each other, and an area of the second optical element and an area of the third optical element are equal.

6. The waveguide display device according to claim 1, wherein the third optical element is configured to couple the light coupled-in by the second optical element out to the human eye in the direction perpendicular to the plane where the third optical element is located.

7. The waveguide display device according to claim 1, wherein the first direction is perpendicular to the second direction.

8. The waveguide display device according to claim 1, wherein the second optical element and the third optical element are parallel to each other.

9. The waveguide display device according to claim 1, wherein the first optical element covers at least a part of the first surface of the waveguide substrate.

10. The waveguide display device according to claim 1, wherein the second optical element covers at least a part of the second surface of the waveguide substrate, the third optical element covers at least a part of the first surface of the waveguide substrate, and the second optical element is opposite to the third optical element.

11. The waveguide display device according to claim 1, wherein the first optical element is a one-dimensional grating, and the second optical element and the third optical element are two-dimensional gratings.

12. The waveguide display device according to claim 1, wherein the first optical element and the third optical element are on the first surface of the waveguide substrate and spaced apart from each other, and the second optical element is on the second surface of the waveguide substrate and opposite to the third optical element.

13. An augmented reality display apparatus, comprising a waveguide display device and an optical machine,
wherein the waveguide display device comprises a waveguide substrate and a first optical element, a second optical element and a third optical element coupled to the waveguide substrate;
the first optical element is located on a first side of the waveguide substrate, the first optical element is adjacent to a first surface of the waveguide substrate and configured to couple a light incident from the optical machine out to the waveguide substrate, and the first surface of the waveguide substrate is a surface of the waveguide substrate facing away from a human eye;
the waveguide substrate is configured to couple the light coupled-in by the first optical element out to the second optical element;
the second optical element and the third optical element are located on a second side of the waveguide substrate, the second optical element is adjacent to a second surface of the waveguide substrate, the second optical element is configured to couple the light coupled-in by the waveguide substrate out to the third optical element in a first direction and a second direction when viewed in a direction perpendicular to a plane where the third optical element is located, and the second surface of the waveguide substrate is a surface of the waveguide substrate facing the human eye;
the third optical element is adjacent to the first surface of the waveguide substrate, the third optical element is configured to couple the light coupled-in by the second optical element out to the second optical element in the first direction or the second direction when viewed in the direction perpendicular to the plane where the third optical element is located, and to couple the light coupled-in by the second optical element out to the human eye, and the light coupled out to the second optical element continues to propagate many times between the second optical element and the third optical element in the first direction or the second direction.

14. The augmented reality display apparatus according to claim 13, wherein the augmented reality display apparatus comprises one of AR glasses, an AR head-mounted display apparatus and a head-up display apparatus.

15. The augmented reality display apparatus according to claim 13, wherein the second optical element is configured to couple the light coupled-in by the waveguide substrate out to the third optical element in the first direction by total reflection, and to couple the light coupled-in by the waveguide substrate out to the third optical element in the second direction by diffraction.

16. The augmented reality display apparatus according to claim 13, wherein the third optical element is configured to couple the light coupled-in by the second optical element out to the second optical element in the first direction or the second direction by total reflection, and to couple the light coupled-in by the second optical element out to the human eye by diffraction.

17. The augmented reality display apparatus according to claim 13, wherein the waveguide substrate is configured to couple the light coupled-in by the first optical element out to the second optical element after the light coupled-in by the first optical element goes through at least one total reflection inside the waveguide substrate.

18. The augmented reality display apparatus according to claim 13, wherein the second optical element and the third optical element are opposite to each other, and an area of the second optical element and an area of the third optical element are equal.

19. The augmented reality display apparatus according to claim 13, wherein the third optical element is configured to couple the light coupled-in by the second optical element out to the human eye in the direction perpendicular to the plane where the third optical element is located.

20. The augmented reality display apparatus according to claim 13, wherein the first optical element and the third optical element are on the first surface of the waveguide substrate and spaced apart from each other, and the second optical element is on the second surface of the waveguide substrate and opposite to the third optical element.
